(19) United States
(12) Patent Application Publication
(10) Pub. No.: US 2007/0158246 A1
(43) Pub. Date: Jul. 12, 2007

(54) Coagulation detection

(75) Inventors: Robert John Davies, Cambridge (GB); Steven Howell, St. Fillans (GB); David Edward Williams, Bedford (GB)

Correspondence Address: STEPTOE & JOHNSON LLP, 1330 CONNECTICUT AVENUE, N.W., WASHINGTON, DC, 20036, US

(73) Assignee: INVERNESS MEDICAL SWITZERLAND GMBH, ZUG (CH)

(21) Appl. No.: 10/576,729

(22) PCT Filed: Oct. 21, 2004
(86) PCT No.: PCT/GB04/04462

§ 371 Date: Jan. 4, 2007

(30) Foreign Application Priority Data
Oct. 22, 2003 (GB) 0324641.0

(51) Int. Cl. B01D 35/00

(52) U.S. Cl. 210/85

(57) ABSTRACT

A coagulation detecting apparatus has a structure defining a container for a fluid, and containing particles for movement through the container under the influence of a magnetic field. A magnetic arrangement provides sequential magnetic fields to the container such as to cause the particles to move. A light source illuminates the container and a detector detects optical radiation of the light source after passing through the container, the detector being arranged for optically detecting at least one of presence of the particles at a predetermined location in the fluid and movement of the particles through a predetermined location in the fluid.

The present invention relates to a method of detecting coagulation of a fluid, to apparatus constructed and arranged to detect coagulation of a fluid, to apparatus for detecting coagulation of a fluid, to a device for detecting coagulation of a fluid and to a structure for use with such a device.

In embodiments, the method and apparatus may be used to determine the coagulation or prothrombin time (PT) of a sample of blood or plasma This may be expressed as an Internationalised Normalised Ratio (INR). Other disturbances of haemostasis that may be determined include measurement of the degree of platelet aggregation, the rate or amount of clot formation and/or clot dissolution, the time required for forming a fibrin clot, the activated partial thromboplastin time (APTT), the activated clotting time (ACT), the protein C activation time (PCAT), the Russell's viper venom time (RVVT) and the thrombin time (TT).

Various apparatus have been developed for use in the laboratory and as point of care testing (POCT). In addition to this, devices have been developed which allow patients to home-monitor their blood coagulation, such as the CoaguChek Plus™ coagulation meter.

The fluid may be blood or plasma.

Many type of apparatus have been proposed for determining the coagulation time of fluids, especially blood. Many of these have disadvantages for example high cost and a large sample requirement which make them awkward to use. In the field of blood coagulation measurements, it is desirable to use a small quantity of blood for the comfort of the patient.

According to one aspect of the invention there is provided a method of detecting coagulation of a fluid comprising providing a magnetic field to cause particles to move within the fluid, illuminating the fluid and optically detecting at least one of presence of the particles at a predetermined location in the fluid and movement of the particles through a predetermined location in the fluid.

In one embodiment the magnetic field is such as to cause the particles to translate within the fluid.

According to another aspect of the invention there is provided a method of detecting coagulation of a fluid comprising providing a magnetic field to cause particles to move to and from within the fluid, illuminating the fluid and optically detecting at least one of presence of the particles at a predetermined location in the fluid and movement of the particles through a predetermined location in the fluid.

According to a further aspect of the invention there is provided a method of detecting coagulation of a fluid comprising providing a container holding said fluid, applying a magnetic field at one zone of a container whereby particles move towards said one zone through the fluid, applying a magnetic field at another zone of said container whereby said particles move through said fluid towards said another zone, illuminating the fluid and optically detecting at least one of presence of the particles at a predetermined location in the fluid and movement of the particles through a predetermined location in the fluid.

In an embodiment said one zone is one end of the container and said another zone is a substantially opposite end of the container.

In an embodiment the particles are paramagnetic.

In an embodiment the particles are superparamagnetic.

In an embodiment there is provided at least one electromagnet, and the method includes selectively controlling current applied to the or each electromagnet.

According to yet a further aspect of the invention there is provided apparatus constructed and arranged to detect coagulation of a fluid comprising a controllable magnetic arrangement operable to provide a magnetic field such as to cause particles to move within the fluid, a light source operable to illuminate the fluid and an optical detector operable to detect at least one of presence of the particles at a predetermined location in the fluid and movement of the particles through a predetermined location in the fluid.

Embodiments of the invention provide a way to determine the coagulation time of blood using a low cost illuminator/detector pair to interrogate a blood sample for the presence or absence of particles that move under the influence of a magnetic field.

In some embodiments optical measurement of the particles takes place when the particles are stationary; in others the measurements occur when the particles are moving. Where stationary measurements are used, the output of the detector, or the input from the illuminators, or both may be gated in synchronism with spaces between the current pulses providing the magnetic pulses to cause particle movement.

In yet other embodiments optical measurement in the measuring zone is carried out regularly, say every 5-10 mS, and the noise level is assessed. Coagulation will have occurred when the noise changes abruptly or falls to zero.

In still further embodiments, the signal from the sensor is gated to open a window at a set time after an electromagnet is actuated. The period is selected according to the position chosen as the measuring zone so that movement of the particles through the measuring zone (if the movement is able to occur) is in fact occurring. Then the noise is compared from one window to the next to determine when coagulation takes place.

According to a further aspect of the invention there is provided apparatus for detecting coagulation of a fluid, the apparatus comprising a structure defining a container for a said fluid, the structure further containing particles for movement through the container under the influence of a magnetic field; a magnetic arrangement for providing sequential magnetic fields to the container such as to cause the particles to move; a light source for illuminating the container and a detector for detecting optical radiation from the light source after passing through the container, the detector being arranged for optically detecting at least one of presence of the particles at a predetermined location in the fluid and movement of the particles through a predetermined location in the fluid.

The particles may be held within the container prior to introduction of said fluid into the container.

According to a still further aspect of the invention there is provided a device for detecting coagulation of a fluid, by means of a structure defining a container for a said fluid, the structure further containing particles for movement through the container under the influence of a magnetic field, the device comprising: means for engaging a said structure in a defined region of said device; a magnetic arrangement for sequentially providing a first magnetic field across the defined region and a second magnetic field across the defined region wherein the first magnetic field has a first sense substantially different to a second sense of the second magnetic field; a light source for illuminating at least a part of the defined region and a detector for detecting optical radiation from the light source after passing through the defined region, the detector being arranged for optically detecting at least one of presence of the particles at a predetermined location in the fluid and movement of the particles through a predetermined location in the fluid.

The detector may be disposed to detect light transmitted from one side of the defined region to an opposite side.

The detector may be disposed to detect light reflected back from within the defined region.

The structure may comprise plural laminae, respective laminae defining one or more sample chambers, and channelling for introduction into the or each sample chambers of a sample of fluid.

At least one lamina may have a notch at one end for sample application

At least one sample chamber contains particles that are arranged in use to be movable through a fluid in a sample chamber.

The particles may be superparamagnetic.

The particles may be paramagnetic.

Exemplary embodiments of the invention will now be described with reference to the accompanying drawings, in which:

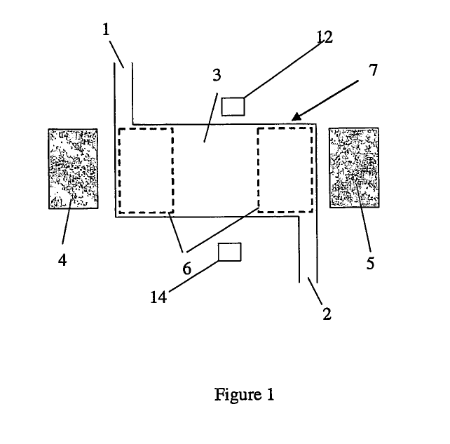

FIG. 1 shows a block schematic drawing of part of first apparatus embodying the invention;

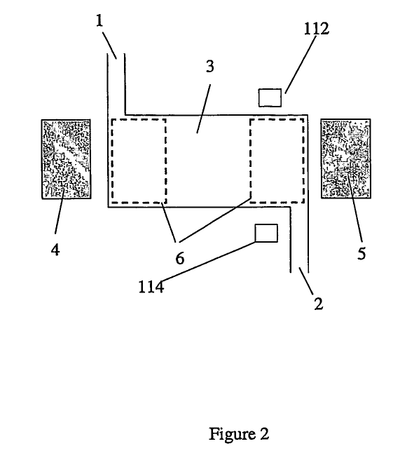

FIG. 2 shows a block schematic drawing of part of second apparatus embodying the invention;

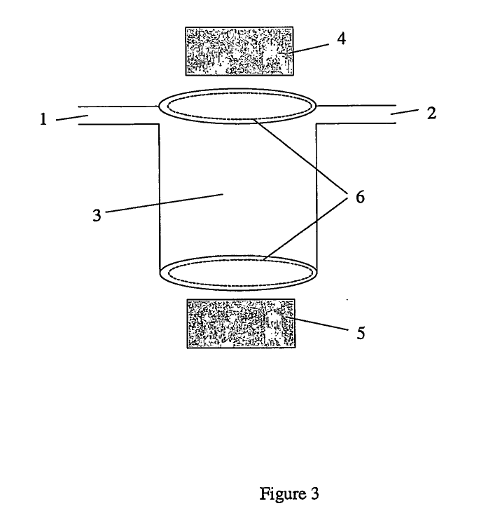

FIG. 3 shows a block schematic drawing of part of third apparatus embodying the invention;

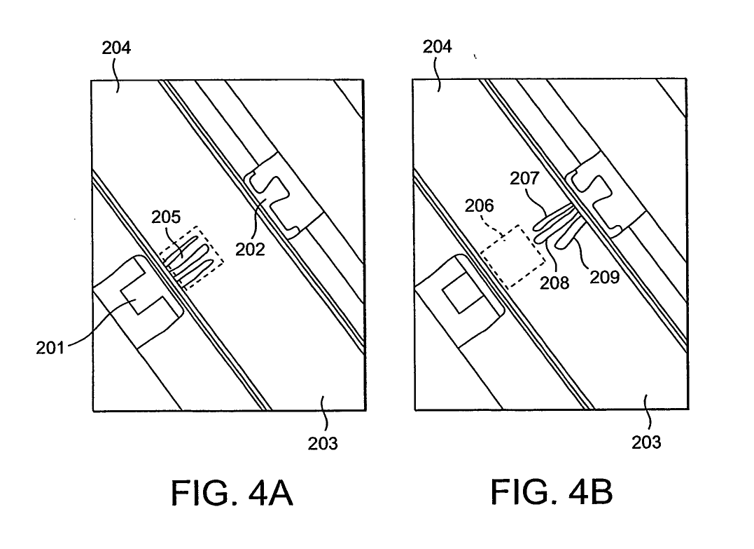

FIG. 4 shows a glass capillary being used to demonstrate a method embodying the invention;

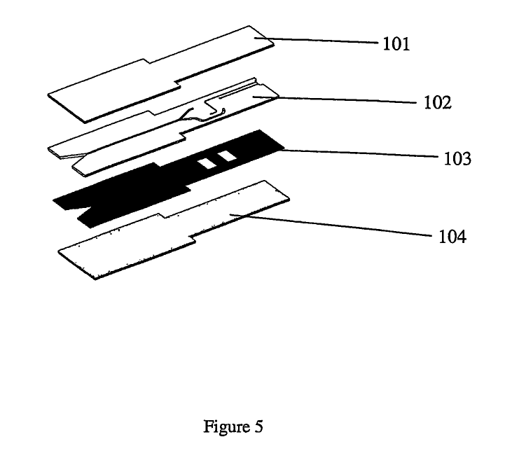

FIG. 5 shows an exploded diagram of one embodiment of a test chamber for use in method and apparatus embodying the invention;

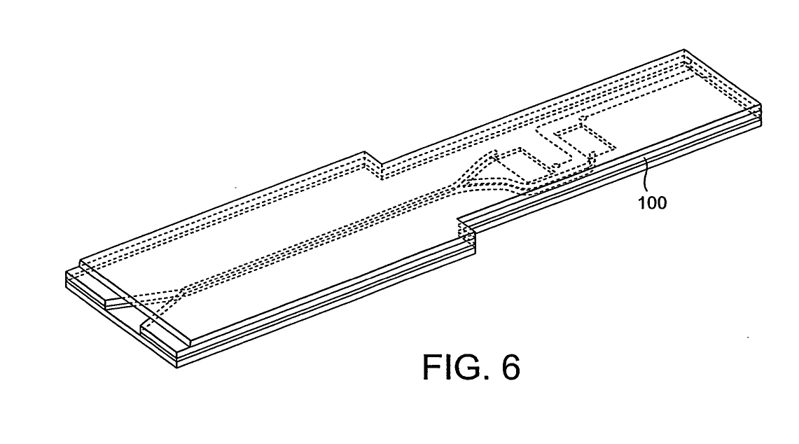

FIG. 6 shows a perspective view of the assembled test chamber of FIG. 5; and

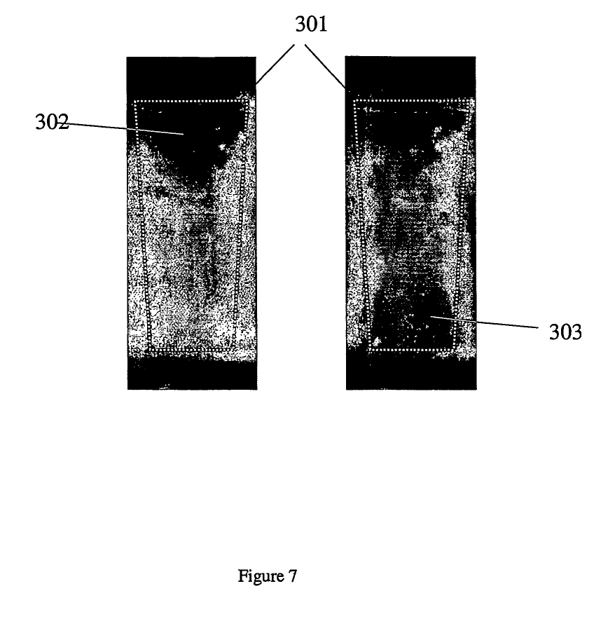

FIG. 7 shows a cross-sectional view of a chamber useable in the invention.

FIG. 1 depicts the top view of a container (7) whose walls define a flat thin generally rectangular chamber (3) that has an inlet (1) and an exit (2) channel, in this embodiment at its respective opposite ends. Some or all of the walls may be transparent—in one embodiment the walls are all transparent and are of plastics such as polyester, polystyrene or polycarbonate. The chamber has a length between opposite ends and a width across opposite sides, the width being diagrammatically shown as around one half the length. The inlet and exit channels (1,2) extend in mutually opposite directions from the container (7) in this embodiment. The apparatus has a pair of relatively low power electromagnets (4,5) and a holder (not shown) for engaging or locating the container (7) in a defined region of the apparatus with respect to the electromagnets such that the electromagnets (4,5) are generally aligned with a longitudinal axis of the container (7); in this embodiment each electromagnet is outside the container (7) adjacent a respective end. The requirement is that the electromagnets be spaced apart sufficiently to allow magnetised particles in a chamber to move away from and out of a zone proximate one electromagnet towards the other; more than two electromagnets may be provided. The apparatus further comprises a drive circuit (not shown) to power the magnets (4,5); in this embodiment, each magnet is driven with current in a non-overlapping fashion, but other arrangements are possible.

In this embodiment the chamber (3), when in the dry state, contains particles (not shown) that will in use move under the influence of a magnetic field, as well as reagents (not shown) that promote the coagulation of blood. The particles in this presently described embodiment are superparamagnetic particles. The particles become suspended in solution upon contact with a blood sample and traverse the chamber as the electromagnets are alternately switched on and off. The particle movement may stir the sample and an initial more rapid movement may be such as to stir the reagent into solution.

The apparatus includes a light source, such as an LED (14), disposed such that when the container (7) is engaged at its defined location, the LED (14) may illuminate a portion of liquid contained within it. As shown, in this embodiment, the LED (14) is disposed about half way along the length of the container to illuminate it transversely across its width. The apparatus further includes a detector (12) disposed such that when the container (7) is engaged at its defined location, light or other optical radiation from the LED (14) may be measured. In one embodiment, the detector (12) is disposed to measure reflected light; in another the detector (12) is disposed to measure transmitted light. In some embodiments screens or appropriate baffling prevent direct input from the illuminator (14) to the detector (12). As shown, in this embodiment, the detector, e.g. a photodiode, is disposed about half way along the length of the container to receive light from the LED (14) across the transverse width of the container (7).

In other embodiments light guides or the like may couple one or both of the LED and detector to the sensing region of the device.

In the embodiment shown in FIG. 1, the diode (14) is positioned such that the particles are illuminated whilst moving.

In another embodiment as shown in FIG. 2, an LED (114) and photodetector (112) are positioned opposing one another across the width of the container (7) but in one end region such that the particles are illuminated when stationary after being attracted to the respective electromagnet (5). In this second embodiment, particles are moved to one electromagnet (5), which is subsequently switched off. Then, the particles are illuminated. The polarity of the electromagnets is then reversed and the particles then move across the chamber. More than one LED may be employed, for example, one positioned at each end of the chamber.

In some embodiments the light source (14) is selected to have a wavelength that has low reflection from the blood but high reflection from the particles; in others the opposite arrangement applies. In yet other embodiments the light source (14) is time-modulated to enable removal ambient light and other electromagnetic effects from the resulting measurements.

Measuring the presence or absence of particles from a portion of the chamber is therefore relatively straightforward due to the direct timing control exercised over the electromagnets. The particle movement is monitored until some time that the change in signal is detected indicating coagulation or a change in viscosity.

In some embodiments optical measurement in the measuring zone is carried out regularly, say every 5-10 mS, and the noise level due to the particles is assessed. Coagulation will have deemed to have occurred when the noise changes abruptly or falls to zero.

In still further embodiments, a signal from the detector is gated to open a window at a set time after an electromagnet is actuated. The period is selected according to the position chosen to be the measuring zone so that movement of the particles through the measuring zone (if the movement is able to occur) is in fact occurring. Then the noise is compared from one window to the next to determine when coagulation takes place.

The container (7) in which the sample is held can be various designs and shapes.

In one embodiment of the invention the chamber is thin and flat in profile having dimensions where the top surface to be interrogated is 1-10 mm in each dimension and the chamber having a thickness in the range 10-500 μm. In one embodiment the chamber has a top surface to be interrogated of 1 mm×2 mm and is 100 μm in thickness. FIG. 1 depicts the top view of a container (7) defining a flat thin chamber (3) that has an inlet (1) and an exit (2) channel, which may be of capillary dimensions. Within the chamber there are detection zones (6) that can be interrogated for the presence or absence of particles. The particles are moved into and out of the field of view of the detection zones via electromagnets (4 and 5). The movement may be to and from along the chamber and through the stationary sample which is retained in the chamber in at least some embodiments by capillarity. In some embodiments one or more of the fluid conduits of the chamber are capable of acting as light guides to transfer light into or out of the chamber.

In another embodiment of the invention shown in FIG. 3 the chamber is cylindrical in nature having dimensions where the top surface has an area of 0.25-10 mm² and a length of 0.5-2 mm. One embodiment of the chamber has a top surface area of 0.5 mm² and a length of 1.6 mm.

Referring to FIG. 3 a cylindrical chamber has a chamber body (7) defining a chamber (3) with an inlet channel (1) and an exit channel (2). The chamber (3) has detection zones located towards the top and bottom surfaces of the chamber (6). The detection zones are interrogated for the presence or absence of particles. The particles are moved via electromagnets (4 and 5). The inlet and outlet channel can be along the same plane as shown in FIG. 3. In other embodiments they may be located such that one channel is in close proximity to the top surface and one channel is in close proximity to the bottom surface.

### EXAMPLES

A first-off illuminator/detector pair was tested with blood and Liquid Research particles in a Camlab capillary. The hardware was un-optimised in respect to wavelength, modulation, gain, isolation and placement tolerance. A steady and repeatable 2 mv signal change is detected readily using this set-up.

Detection of Particles in a Flat Thin Chamber

Super paramagnetic particles [Liquids Research, cat number SC(2)] were mixed into 2 ml of sucrose at 3% (w/v). An aliquot of particles (5 μl) was mixed with 20 μl of fresh venous whole blood. The blood containing particles was pippetted into a glass capillary (Camlab laboratory products, Cambridge, UK cat number VD/3520-100) and the glass capillary was inserted between two electromagnets (RS, cat number 3305213).

FIGS. 4a and 4b show a glass capillary having external dimensions of 2.4 mm width, 50 mm in length and 600 um thickness (internal dimensions of 2 mm width and 200 um thickness) inserted between two electromagnets (201 and 202). The glass capillary has open ends and so have an inlet (203) and an air-venting exit (204). The electromagnets were driven by a simple electrical circuit that passed current at 60 mA into one electromagnet (201) for a duration of 250 ms and then switched the 60 mA current into a second electromagnet (202) for a duration of 250 ms, this was then repeated a number of times. As can be seen in FIG. 4a when the electromagnet (201) has current passing through it the super paramagnetic particles are located in a region (205) close to the electromagnet (201). By comparison in FIG. 4b when the electromagnet (202) has current passing through it the superparamagnetic particles are no longer within this region (206). It is possible to detect the presence or absence of particles within region (205) either using a simple camera system or using changes in light intensity from the surface.

Thromboplastin (Innovin™, Dade Behring) and super paramagnetic particles can be mixed with fresh whole blood and the sample placed in the glass capillary. The electromagnets can be turned on and off and the presence or absence of particles can be determined as described above. The Prothrombin Time can be determined by a change in the periodicity of the particles appearing and moving out of the detection zone.

The profile of the alignment of the super paramagnetic particles within the generated magnetic field can be as “fingers” (207, 208 and 209) or as one mass (not shown) depending on the particle type and magnetic field generated.

Manufacturing Methods

A test chamber may be made using a relatively simple multi-layer (four layers or more) laminate construction to provide a low blood volume test device. Referring to FIGS. 5 and 6, in one embodiment a test device (100) is constructed from first-fourth sequential layers (numbered 101 to 104 from top to bottom as illustrated) of mylar type materials with thickness in the range from 100 um to 200 um each to provide an overall device thickness of around 600-800 um for stability. First layer (101) and fourth layer (104) are made of a material with low contact angle or treated on the underside and topside respectively to promote flow characteristics. First-third layers (101, 102 and 103) have features cut to the full depth of the material. First layer (101) has simple squares cut to match the sample application feature in second and third layers (102) and (103). Second layer (102) has an adhesive coating on the top surface whilst third layer (103) has adhesive coatings on both sides. In some embodiments adhesive coatings have hydrophilic properties. In some embodiments the bottom of second layer (102) is treated to provide enhanced flow characteristics into the detection chambers. Second layer (102) contains a sample application feature (such as a notch), channelling to transport the blood sample to the corners of the detection chambers (two in the described embodiment) and venting channels/features at the opposite corners of the detection chambers. Third layer (103) contains a similar sample application feature to second layer (102) and also contains the detection chambers (2 mm by 1 mm).

Construction: The adhesive protector on the topside of second layer (102) is removed and second layer (102) is adhered to first layer (101) with simple alignment of the squares in layer one with the sample application features in second layer (102). The adhesive protector on the bottom side of third layer (103) is removed and third layer (103) is adhered to fourth layer (104) with no alignment. The reagents and particles that move in a magnetic field are dosed into the detection chambers. The adhesive protector on the topside of third layer (103) is removed and the two sub-assemblies are adhered to each other using the sample application feature and detection chambers as alignment guides. The construction process is envisaged to take place on a sheet basis initially where additional handling guides could be built into the layers and eventually on a web manufacturing process. The test strips once formed on a sheet or web basis would then be cut out as individual parts.

Other embodiments include more than two detection chambers, by the use of a separation layer between second and third layers (102) and (103). In some embodiments second layer (102) has adhesive on both sides. The separation layer then does not require any adhesive layers. Additional detection chambers are introduced in third layer (103) with fluidic separation from the channelling in second layer (102). Another embodiment includes mini-wells for the deposition of reagents and particles through the use of an additional layer with adhesive on the underside between third and fourth layers (103) and (104). This layer has smaller through holes (e.g. 2 per detection chamber) to coincide with the detection chamber holes in third layer (103).

FIG. 5 shows the four layers described in the first embodiment with the parts cut out as individual parts—first layer (101) therefore does not have squares cut in the area of the sample application feature in second layer (102) (these are lost). FIG. 6 shows the assembled device.

This provides a low cost manufacturing method and design for a multiple detection chamber measurement strip with low sample volume (sub micro-litre) for the measurement of blood coagulation.

Manufacturing constraints are also eased by providing a simple laminate based, multi-layer (four or more), construction system with in-built fluidic separation to the required level for the detection of blood coagulation.

This also may provide major flow surfaces that are free of adhesive coatings.

The sample inlet into the chamber, being via the top layer, is not affected by the deposition of particles and reagents.

Detection of Particles in a Cylindrical Chamber

Superparamagnetic particles (Polymer laboratory) were mixed into 2 ml of sucrose at 3% (w/v). An aliquot of particles (60 nl) was deposited into an injection moulded plastic chamber (prepared using conventional injection moulding techniques). The contents of the plastic chamber were dried by subjecting the plastic part to infra-red radiation using a halogen short wave infra-red bulb (Philips Lighting, RS250-1050) producing a surface temperature of 55° C. for 3 minutes). The plastic part was covered with a hydrophobic laminate (3M, cat number 9795) and then inserted between two electromagnets. The apparatus was heated to 37° C. by placing in a thermostatically controlled chamber. Fresh venous whole blood was pippetted onto the plastic part and allowed to migrate by capillary action into the chamber.

FIG. 7 shows a cross section of the plastic chamber. The chamber is shown outlined (301) and has dimensions of approximately 0.5 mm² top surface area, 0.3 mm² bottom surface area and a depth of 1.6 mm. When the electromagnet located above the chamber (not show) has current applied the particles migrate towards the top of the chamber (302) and when the electromagnet located below the chamber (not shown) has current applied the particles migrate towards the bottom of the chamber (303). It is possible to detect the presence or absence of particles within the chamber either using a simple camera system or using changes in light intensity from either a side on view as seen in FIG. 8 or from the top and/or bottom surfaces of the chamber.

Using the optical approach of the present invention, it is possible to create embodiments where sample volume in the chamber is reduced to 200 nL. Close location of the optics is not necessary and particles can be moved in the x/y plane allowing a shallow detection chamber.

Use of a shallow chamber also allows for dosing of reagents into the normal ‘dosing’ plane (e.g. x/y) and also reduces the overall depth of the detection chamber and the blood volume required (sub-micro-litre) to run the test.

A double-sided design is used to allow channelling on one side of the device and detection chambers on the reverse side of the device. Due to the design the detection chambers can be shallow in the z dimension (around 100 um deep) thereby reducing the blood volume required considerably whilst being large in the x and y directions (around 1 mm by 2 mm) thereby easing constraints on particle and reagent dosing.

The device also eases constraints on blood sample filling due to the detection chamber itself being of capillary dimensions and the feed channel/detection chamber interface being at the natural corner of the detection chamber.

In some embodiments there are further chambers, and one or more may have no reagent or a coagulation retardant agent. One or more of such further chambers may form a control.

Although the described embodiments have chambers separable from the sensing assembly, it is alternatively possible to provide a full disposable type apparatus in which the chamber or chambers is/are integral with the sensing assembly.

Various embodiments of the invention have been described herein. The invention is not to be taken as limited to the arrangements described but extends to the full scope of the appended claims.

1. A method of detecting coagulation of a fluid comprising providing a magnetic field to cause particles to move within the fluid, illuminating the fluid and optically detecting at least one of presence of the particles at a predetermined location in the fluid and movement of the particles through a predetermined location in the fluid.

2. A method as claimed in claim 1, wherein the magnetic field is such as to cause the particles to translate within the fluid.

3. A method of detecting coagulation of a fluid comprising providing a magnetic field to cause particles to move to and from within the fluid, illuminating the fluid and optically detecting at least one of presence of the particles at a predetermined location in the fluid and movement of the particles through a predetermined location in the fluid.

4. A method of detecting coagulation of a fluid comprising providing a container holding said fluid, applying a magnetic field at one zone of a container whereby particles move towards said one zone through the fluid, applying a magnetic field at another zone of said container whereby said particles move through said fluid towards said another zone, illuminating the fluid and optically detecting at least one of presence of the particles at a predetermined location in the fluid and movement of the particles through a predetermined location in the fluid.

5. A method according to claim 4, wherein said one zone is one end of the container and said another zone is a substantially opposite end of the container.

6. A method as claimed in claim 1 wherein the particles are paramagnetic.

7. A method as claimed in claim 1, wherein the particles are superparamagnetic.

8. A method as claimed in claim 1 wherein there is provided at least one electromagnetic, wherein the method includes selectively controlling current applied to the or each electromagnet.

9. Apparatus constructed and arranged to detect coagulation of a fluid comprising a controllable magnetic arrangement operable to provide a magnetic field such as to cause particles to move within the fluid, a light source for illuminating the fluid and a detector for optically detecting at least one of presence of the particles at a predetermined location in the fluid and movement of the particles through a predetermined location in the fluid.

10. Apparatus according to claim 7, wherein the fluid is blood.

11. Apparatus for detecting coagulation of a fluid comprising
a structure defining a container for a said fluid, the structure further containing particles for movement through the container under the influence of a magnetic field;
a magnetic arrangement for providing sequential magnetic fields to the container such as to cause the particles to move;
a light source for illuminating the container; and
a detector for detecting optical radiation from the light source after passing through the container, the detector being arranged for optically detecting at least one of presence of the particles at a predetermined location in the fluid and movement of the particles through a predetermined location in the fluid.

12. Apparatus according to claim 11, wherein the particles are held within the container prior to introduction of said fluid into the container.

13. A device for detecting coagulation of a fluid, by means of a structure defining a container for a said fluid, the structure further containing particles for movement through the container under the influence of a magnetic field, the device comprising:
means for engaging a said structure in a defined region of said device;
a magnetic arrangement for sequentially providing a first magnetic field across the defined region and a second magnetic field across the defined region wherein the first magnetic field has a first sense substantially different to a second sense of the second magnetic field;
a light source for illuminating at least a part of the defined region; and
a detector for detecting optical radiation from the light source after passing through the defined region, the detector being arranged for optically detecting at least one of presence of the particles at a predetermined location in the fluid and movement of the particles through a predetermined location in the fluid.

14. A device according to claim 13, wherein the detector is disposed to detect light transmitted from one side of the defined region to an opposite side.

15. A device according to claim 13, wherein the detector is disposed to detect light reflected back from within the defined region.

16. A structure for use with a device of claim 13, the structure comprising plural laminae, respective laminae defining one or more sample chambers, and channelling for introduction into the or each sample chambers of a sample of fluid.

17. A structure according to claim 16, wherein at least one lamina has a notch at one end for sample application.

18. A structure according to claim 16, wherein at least one sample chamber contains particles that are arranged in use to be movable through a fluid in a sample chamber.

19. A structure as claimed in claim 16, wherein the particles are superparamagnetic.

20. A structure as claimed in claim 16, wherein the particles are paramagnetic.
